(19) United States
(12) Patent Application Publication
(10) Pub. No.: US 2004/0036401 A1
(43) Pub. Date: Feb. 26, 2004

(54) Field electron emission apparatus and method for manufacturing the same

(76) Inventors: Kazuo Konuma, Tokyo (JP); Yoshinori Tomihari, Tokyo (JP); Yuko Okada, Tokyo (JP)

Correspondence Address: Paul J Esatto Jr, Scully Scott Murphy & Presser, 400 Garden City Plaza, Garden City, NY, 11530, US

(21) Appl. No.: 10/362,479

(22) PCT Filed: Aug. 24, 2001
(86) PCT No.: PCT/JP01/07272

(30) Foreign Application Priority Data
Aug. 25, 2000 (JP) 2000254980
Mar. 30, 2001 (JP) 200198468

(51) Int. Cl. H01J 9/24; H01J 9/00

(52) U.S. Cl. 313/311; 445/24

(57) ABSTRACT

To provide a method for manufacturing a high-performance field electron emission apparatus, wherein occurrence of damage to a CNT during a manufacturing step is prevented, and thereby, the CNT can adequately keep an inherent electron emission characteristic of exhibiting a large current density with a low threshold value. This method for manufacturing a field electron emission apparatus is related to the manufacture of a field electron emission apparatus using the CNT as an electron source. In the method, a protective film formation step is performed in order to form an aluminum film 4 as the protective film on the surface of the CNT film 2 during a manufacturing process of at least a part of the apparatus. The CNT surface structure is protected with this conductive protective film (aluminum film 4, 40), while the structure significantly affects the electron emission characteristic. Consequently, the electron emission characteristic inherent in the CNT can be adequately ensured and be exhibited.

### TECHNICAL FIELD

The present invention relates to a field electron emission apparatus using a carbon fine-structure material (hereafter referred to as a CNT) primarily containing carbon nanotubes as an electron source. In particular, the present invention relates to a field electron emission apparatus, for example, a field emission display (hereafter referred to as an FED), and a method for manufacturing the same. The FED is a flat-panel display device of the type in which at least one electron gun is used, a phosphor is hit so as to form one pixel, and pixels are integrated in the same number as that of the pixels in an image.

### BACKGROUND ART

This type of CNT is used as an electron source in conventionally known some types of field electron emission apparatus. For example, an electron generation device is disclosed in Japanese Unexamined Patent Publication (JP-A) No. 10-199398, and has a structure in which a CNT is laminated as an electron source. Specifically, graphite as a cathode is arranged on a substrate, a CNT layer as the electron source is formed linearly on the graphite, and insulation layers are arranged on both sides thereof. Furthermore, in the structure, a grid electrode is formed on the insulation layer perpendicularly to the cathode line, and when a voltage is applied between the grid electrode and the cathode, electrons are emitted from the CNT as an electron emission portion.

Regarding a flat-panel display disclosed in Japanese Unexamined Patent Publication (JP-A) No. 11-297245, an electron source is composed of a CNT. Specifically, the structure includes a display surface and a cathode substrate, and a voltage is applied to the cathode substrate and the display surface. In a display portion as the display surface, first ribs are arranged at a predetermined spacing, and phosphors are arranged between the first ribs. Regarding the cathode substrate, second ribs are arranged perpendicularly to the first ribs at a predetermined spacing, and electron emission portions are arranged between the second ribs. Here, the CNT is formed into a predetermined pattern by screen printing, etc., and is used as the electron source of the electron emission portion.

Examples of other publicly known technologies related to such a CNT include a phosphor display device and a method for manufacturing the same disclosed in Japanese Unexamined Patent Publication (JP-A) No. 11-329312, a method for manufacturing an electron emission source disclosed in Japanese Unexamined Patent Publication (JP-A) No. 2000-36243, and a field emission cathode, an electron emission element, and a method for manufacturing a field emission cathode disclosed in Japanese Unexamined Patent Publication (JP-A) No. 2000-90809.

Regarding the aforementioned electron emission device using the CNT as the electron source, a problem occurs in that the formed CNT is damaged due to chemical and physical actions during the manufacturing step thereof, and thereby, the CNT cannot achieve an inherent electron emission characteristic of exhibiting a large current density with a low threshold value.

Known reasons for the aforementioned damage to the CNT include that, for example, the CNT is burned by oxygen as an oxidizing agent and the CNT is consumed by reactions with acidic or basic agents during a heating step, etc. Even when the burning does not occur, the fine structure of the CNT may disappear due to the impact of ions during a dry etching step, or the fine structure may disappear due to the contact with plasma during a plasma treatment.

Therefore, in the manufacturing process of the field electron emission apparatus using the CNT as the electron source, it is considered that an influence is exerted by burning of the CNT or disappearance of the fine structure during the etching step, for example, the formation of an insulation layer performed after the formation of the CNT and the formation of a gate electrode performed after the formation of the insulation layer, and the CNT disappears by burning during the heating step. In particular, regarding a single-layer CNT, the CNT reacts with oxygen in an oxygen-containing atmosphere at 400° C. or more, and thereby, the CNT is impaired, and the efficiency of the electron emission is decreased.

Accordingly, it is an object of the present invention to provide a high-performance field electron emission apparatus and a method for manufacturing the same, wherein occurrence of damage to a CNT during a manufacturing process is prevented, and thereby, the CNT can adequately keep an inherent electron emission characteristic of exhibiting a large current density with a low threshold value.

### DISCLOSURE OF INVENTION

According to the present invention, a method for manufacturing a field electron emission apparatus is provided, while the apparatus uses a CNT as an electron source. This method for manufacturing a field electron emission apparatus includes a protective film formation step of forming a protective film on the surface of the CNT during a manufacturing process of at least a part of the apparatus.

In the aforementioned method for manufacturing a field electron emission apparatus, steps to be performed in the protective film formation step may include a heating step, a heat treatment step, a plasma treatment step, a plasma etching step, a step of forming a film in any one of a gas phase, plasma, a liquid phase and a solid phase, a step of performing an etching with a solution or a surface treatment, and at least one of the steps of resist coating, resist development and resist peeling, so that a method for manufacturing a field electron emission apparatus is further provided according to the present invention.

In any one of the aforementioned methods for manufacturing a field electron emission apparatus, the protective film may have conductivity in the protective film formation step, so that a method for manufacturing a field electron emission apparatus is further provided according to the present invention.

In any one of the aforementioned methods for manufacturing a field electron emission apparatus, the protective film formation step may include a step of exposing the protective film in plasma while the protective film is arranged on the surface of the CNT, so that a method for manufacturing a field electron emission apparatus is further provided according to the present invention. In this method for manufacturing a field electron emission apparatus, preferably, the protective film formation step further includes a step of removing a part of the protective film by chemical etching.

In any one of the aforementioned methods for manufacturing a field electron emission apparatus, aluminum may be used as the protective film, so that a method for manufacturing a field electron emission apparatus is further provided according to the present invention. In this method for manufacturing a field electron emission apparatus, preferably, the aluminum has an film thickness of 600 nm or more. In these methods for manufacturing a field electron emission apparatus, preferably, the CNT is formed by deposition onto a titanium metal wiring.

In any one of the aforementioned methods for manufacturing a field electron emission apparatus, the method may include the step of depositing a gate metal after ashing is applied to the CNT with the protective film on the surface thereof, so that a method for manufacturing a field electron emission apparatus is further provided according to the present invention.

In any one of the aforementioned methods for manufacturing a field electron emission apparatus, the method may include the steps of depositing a gate metal onto the protective film, followed by patterning, and thereafter, exposing to ashing plasma, so that a method for manufacturing a field electron emission apparatus is further provided according to the present invention.

In the aforementioned methods for manufacturing a field electron emission apparatus, the protective film may be exposed to the ashing plasma while a part of or all of an emitter hole inner wall is covered with the gate metal, so that a method for manufacturing a field electron emission apparatus is further provided according to the present invention.

In the aforementioned method for manufacturing a field electron emission apparatus, the method may include a step of removing the gate metal covering the emitter hole inner wall after the protective film is exposed to the ashing plasma, so that a method for manufacturing a field electron emission apparatus is further provided according to the present invention.

According to the present invention, another method for manufacturing a field electron emission apparatus is provided, while the apparatus uses a CNT as an electron source. This method for manufacturing a field electron emission apparatus includes a step of reforming the CNT into titanium nitride by performing a heat treatment after a titanium film is formed on the surface of the CNT.

According to the present invention, another method for manufacturing a field electron emission apparatus is provided, while the apparatus uses a CNT as an electron source. This method for manufacturing a field electron emission apparatus includes a step of forming fine particles of aluminum by performing a heat treatment after an aluminum film is formed on the surface of the CNT in the method for manufacturing a field electron emission apparatus while the apparatus uses the CNT as the electron source.

According to the present invention, another method for manufacturing a field electron emission apparatus is provided, while the apparatus uses a CNT as an electron source. This method for manufacturing a field electron emission apparatus includes a step of forming a structure in which the protective film remaining in the vicinity of the CNT is pointed at a right or acute angle in the method for manufacturing a field electron emission apparatus while the apparatus uses the CNT as the electron source.

According to the present invention, a field electron emission apparatus is provided. The apparatus is manufactured by any one of the aforementioned methods for manufacturing a field electron emission apparatus while a part of the protective film remains.

In this field electron emission apparatus, preferably, the protective film has conductivity and has a structure including a further function as a cathode wiring, the protective film is arranged in contact with a substrate, as well, including no CNT, an insulation film is laminated on the CNT covered with the protective film and a gate conductive film is laminated on the insulation film, or a portion is provided so as to expose the CNT film, while the portion is brought about by peeling of a part of the insulation film, gate conductive film, and protective film.

In any one of the aforementioned field electron emission apparatuses, the insulation film is arranged between the cathode wiring or carbon nanotube and the gate conductive film, and the insulation film may be any one of an organic material, a photosensitive material, an organic photosensitive material, and a material which changes color in accordance with a heating history, so that a field electron emission apparatus is further provided according to the present invention. In these field electron emission apparatuses, preferably, the insulation film uses any one of a polyimide resin, an epoxy resin, an acrylic resin, an epoxyacrylate resin, an organic silicon-based resin, and SOG (Spin on Glass) as a material.

According to the present invention, in any one of the aforementioned field electron emission apparatuses, preferably, the insulation film is composed of the epoxyacrylate resin having a fluorene skeleton or a benzocyclobutene resin, the insulation film is arranged by curing performed under a heating temperature condition of 300° C. or less, the insulation film changes color in air under a heating temperature condition of 300° C. or more, or the insulation film changes color in an atmosphere of nitrogen under a heating temperature condition of 450° C. or more.

### BRIEF DESCRIPTION OF THE DRAWINGS

FIGS. 1(a) to (d) are sectional side views showing a manufacturing process for a diode-structure emitter (an intermediate product of a field electron emission apparatus) in a step-by-step manner. The process is a specific example of a method for manufacturing a field electron emission apparatus according to Example 1 of the present invention, and the emitter is composed of a cathode plate and a phosphor screen. FIGS. 1(e) and (f) are sectional side views showing stages in a manufacturing process for a field electron emission apparatus. This process is a specific example of a method for manufacturing a field electron emission apparatus according to Example 2 of the present invention. The stages shown in FIGS. 1(e) and (f) are substitutes for the condition of FIG. 1(b) and the condition of FIG. 1(c), respectively, and in the stages, a fine structure is in the condition of being covered with an aluminum film.

FIGS. 2(a) to (f) are sectional side views showing a manufacturing process for a field electron emission apparatus in a step-by-step manner. The process is a specific example of a method for manufacturing a field electron emission apparatus according to Example 3 of the present invention, and in this process, a cathode wiring is arranged on a glass substrate, and thereafter, a CNT film is deposited.

FIGS. 3(a) to (d) are sectional side views showing a manufacturing process for a triode-structure field electron emission apparatus in a step-by-step manner, and this apparatus has a gate conductive film. The process is a specific example of a method for manufacturing a field electron emission apparatus according to Example 4 of the present invention.

FIGS. 4(a) to (d) are sectional side views showing a manufacturing process for a triode-structure field electron emission apparatus in a step-by-step manner, and this apparatus has a gate conductive film. The process is a specific example of a method for manufacturing a field electron emission apparatus according to Example 5 of the present invention.

FIG. 5 is a perspective cutaway view of a part of the basic configuration of an FED as a field electron emission apparatus according to Example 6. In the FED, gate conductive films are arranged by patterning into a stripe-like shape.

FIGS. 6(a) and (b) are sectional side views showing a manufacturing process for a field electron emission apparatus in a step-by-step manner. The process is a specific example of a method for manufacturing a field electron emission apparatus according to Example 7 of the present invention, and in this process, a protective film reacts with a fine structure.

FIG. 7 is a sectional side view showing a step of forming pointed-structure aluminum as a specific example of a method for manufacturing a field electron emission apparatus according to Example 8 of the present invention. An aluminum film is formed as a protective film in the early stages of the manufacturing process of a field electron emission apparatus of each of the aforementioned Examples. Subsequently, a part of the aluminum film is removed, and in that condition, the corner portions of the aluminum film are pointed at a right or acute angle in order that an electric field is concentrated on the corner portions of the aluminum film.

FIG. 8 is a perspective cutaway view of a part of the basic configuration of an FED as a field electron emission apparatus according to Examples 11 and 12. In the FED, gate conductive films are patterned into a stripe-like shape.

### BEST MODE FOR CARRYING OUT THE INVENTION

In order to describe the invention in more detail, this is explained with reference to attached drawings. Initially, a technical outline of a method for manufacturing a field electron emission apparatus of the present invention will be described briefly. In this method for manufacturing a field electron emission apparatus, a protective film formation step is performed when a field electron emission apparatus using a CNT as an electron source is manufactured. This step forms the protective film on the surface of the CNT during a manufacturing process of at least a part of the apparatus.

In this protective film formation step, the protective film has conductivity, and in addition, steps to be performed include a heating step, a heat treatment step, a plasma treatment step, a plasma etching step, a step of forming a film in any one of a gas phase, plasma, a liquid phase and a solid phase, a step of performing an etching with a solution or a surface treatment, and at least one of the steps of resist coating, resist development and resist peeling. In the protective film formation step, a step of exposing in plasma is performed while the protective film is arranged on the surface of the CNT, and furthermore, a step of removing a part of the protective film is performed by chemical etching.

In addition, the field electron emission apparatus may be manufactured by performing a step of reforming a CNT into titanium nitride by performing a heat treatment after a titanium film is formed on the surface of the CNT, forming an aluminum film on the surface of the CNT, performing a step of forming fine particles of aluminum by a further heat treatment, or performing a step of forming a structure in which the protective film remaining in the vicinity of the CNT is pointed at a right or acute angle, in the method for manufacturing a field electron emission apparatus using the CNT as the electron source.

A part of the protective film remains in the field electron emission apparatus manufactured according to such a method for manufacturing a field electron emission apparatus. Preferably, various requirements are satisfied. The requirements include that this protective film has conductivity and has a structure including a further function as a cathode wiring, the protective film is arranged in contact with a substrate, as well, including no CNT, the insulation film is laminated on the CNT covered with the protective film and a gate conductive film is laminated on the insulation film, a portion is provided so as to expose the CNT film while the portion is brought about by peeling of a part of the insulation film, gate conductive film and protective film, and the insulation film is an organic material.

According to the aforementioned various requirements, the CNT surface structure is protected with the protective film while the CNT surface structure exerts a significant influence on the electron emission characteristic. Consequently, an effect is produced so that the electron emission characteristic inherent in the CNT is exhibited. In the case where the protective film has conductivity, when the protective film has a structure including a further function as a cathode wiring, any cathode wiring formation step becomes unnecessary. Furthermore, in the field electron emission apparatus, when the protective film having the further function as a cathode wiring is arranged in contact with the substrate surface, as well, including no CNT while the cathode wiring is arranged continuing from the surface of the CNT, excellent adhesion of the substrate, CNT and protective film is achieved, and an effect is thereby produced so that occurrence of defects, for example, peeling, can be prevented compared with that in the case where a wiring is provided separately. In addition, when the field electron emission apparatus has a structure in which the insulation film and the gate conductive film are laminated on the CNT covered with the protective film, or has a structure in which the insulation film and the gate conductive film are laminated on the CNT covered with the protective film and a part of the CNT is exposed by peeling of a part of the insulation film, effects are produced so that the CNT and the insulation layer can be prevented from directly contacting with each other, and are prevented from adversely affecting each other. Examples of the adverse effects include that, for example, the contact between the CNT and the insulation layer impairs the electron emission characteristic of the CNT, and the contact between the insulation layer and the CNT causes occurrence of the defect in the film thickness uniformity of the insulation layer and the defect in the insulation characteristic. The voltage applied between the CNT and the gate conductive film can be controlled by preventing these adverse effects, and therefore, the electron emission can be controlled.

When this insulation film is an inorganic material and is an SOG (Spin on Glass), the insulation film is excellent in gas release and heat resistance. Furthermore, when the insulation film is formed from an organic material, the firing step at a high temperature is unnecessary while the step is required for formation of the insulation layer from the inorganic material. Therefore, the firing can be performed at a relatively low temperature. Consequently, an effect is produced so as to prevent the damage and burnout due to burning of the CNT during the insulation film formation step.

In addition, when a photosensitive resin is used as the material for the insulation film, an opening of the insulation film is provided easily. If the material for the insulation film is not any photosensitive resin, a photosensitive mask must be formed from resist, etc., and subsequently, the opening must be provided. Consequently, the number of the steps is increased in the manufacturing process. When the insulation film having a large film thickness is removed, dry etching is suitable. However, when the etching is fairly close to completion, the insulation film is exposed to a dry etching gas. When the protective film has even a small hole, the gas cause damage to the CNT, and thereby, the electron emission is impaired. When the dry etching is further performed for a long time, the CNT will be lost. Likewise, when the insulation film is removed by a wet process, the insulation film is exposed to a developing solution for removing the insulation film and the developing solution of a resist for forming a pattern. When the protective film has a small hole, the CNT is exposed to the chemical agent, and the CNT is thereby damaged.

On the other hand, when the photosensitive resin is used as the material for the insulation film, the developing solution dissolves the photosensitive resin. When the photosensitivity is made to be uniform in the surface, unnecessary parts of the resin are likely to dissolve uniformly. Consequently, the CNT arranged under the resin is brought into contact with the developing solution for only a short time, and therefore, the impairment of the CNT is reduced. Here, the developing solution refers to a liquid for selectively removing the part radiated with light or the part radiated with no light of the photosensitive resin, and a releasing solution may be considered to be a sort thereof. When the protective film is formed on the upper portion of the CNT, the protective film may be damaged by the developing solution. For example, since the protective film made of aluminum has the property of dissolving into either of an alkaline solution and an acidic solution, in this case, the protective film is made to remain by adjusting the relationship between the film thickness and development velocity of the insulation film and the film thickness of the protective film made of aluminum and the etching velocity of the protective film attacked by the developing solution. When the development property is uniform in the surface, since the protective film is exposed to the developing solution after the development, the condition for remaining the protective film can be established with ease.

On the other hand, a polyamide resin is an example of an organic material as the material for the insulation film, and exhibits excellent heat resistance and a small gas release. An epoxy resin, an acrylic resin, and an epoxyacrylate resin also exhibit small gas releases, and therefore, can be used in a vacuum. Furthermore, insulation films made of these resin materials are preferably an epoxyacrylate resin having a fluorene skeleton or a benzocyclobutene (BCB) resin. Since the resins having these skeletons are unlikely to decompose by ion radiation, gas release is reduced in the environment of the electron radiation and ion fall in a vacuum container of an FED.

Since the polyimide resin accompanies condensed water during curing, and a photosensitive group included in a molecule is eliminated, a significant film shrinkage occurs during exposure to light. When electron guns use such a material, and are arranged in a large FED, problems occur in that a panel is bent due to the film shrinkage, and cracks occur in the film. In addition, an opening of an insulation film cannot be formed in compliance with the design because the shape of the opening is distorted due to the film shrinkage. Even when the allowance is made for the degree of the film shrinkage during formation, occurrence of variations in a final shape cause variations in electron emission of an FED, and therefore, required uniformity of a display cannot be achieved. Furthermore, since the curing temperature is a high 400° C., the emission efficiency of electron is reduced due to impairment of a CNT.

The epoxy resin is commonly used as an inexpensive resin material. However, since the dielectric constant is high, the capacitance between gate cathodes is increased, and the high-frequency characteristics of an electron gun cannot be expected. In addition, since the thermal expansion coefficient is large, when an FED uses a large glass substrate, distortion occurs during a process, and therefore, the yield is reduced. Since the resolution is low, and the flatness of the cured film is poor, the uniformity is reduced in the electron emission characteristic of the electron gun because of emitter-to-emitter variation in shape.

The organic silicon-based resin uses an organic solvent for a developing solution. Therefore, the resolution becomes poor due to swelling of a cured film of an exposed portion, and an emitter opening cannot be formed with high precision and an excellent shape. When the film is brought into a vacuum after swelling, gases are released from the organic solvent for a long time, and thereby, much time is required to increase the degree of vacuum. In order to maintain a high vacuum of a vacuum panel, such as an FED, evacuation must be performed for a long time while the high temperature condition is maintained. However, since the curing temperature is a high 400° C., the CNT is subjected to impairment.

The epoxyacrylate resin generally has poor solubility, and is not suitable for the purpose of increasing the film thickness and forming a high-resolution shape by using a flame-retardant developing solution. Since the heat resistance and adhesion to a substrate are poor, the shape of an emitter cannot be controlled, and variations occur therein. Consequently, the uniformity of the display is significantly reduced in a large FED, in which electron guns are arranged and are integrated. An opening may not be formed adequately in an insulation film. The insulation film may remain at a low portion of the opening, and it may thereby occur that any opening cannot be provided.

When the epoxyacrylate resin has a fluorene skeleton, the resin has very excellent heat resistance resulting from the structure, and in addition, has high adhesion resulting from a small shrinkage during photopolymerization, excellent transparency, and a high refractive index. Even when the resin has a large thickness, the transmittance is high, and light travels in straight lines during exposure. Consequently, high resolution can be achieved even when the thickness is in the order of 2 μm to 100 μm. When such a material is applied to an FED, an emitter hole is formed so as to have excellent heat resistance and a large film thickness, and excellent adhesion is achieved with respect to a substrate and a gate electrode, in comparison with the aforementioned polyimide resin, epoxy resin, acrylic resin, epoxyacrylate resin having no fluorene skeleton, and SOG (Spin on Glass). In particular, the resulting emitter hole can have high resolution, and can have an aspect ratio exceeding 1. Here, the aspect ratio refers to a hole depth with reference to a diameter of an emitter hole. For example, when the diameter of the emitter hole is 20 μm, if the hole depth is 20 μm, the aspect ratio can be determined as 1, and if the hole depth is 30 μm, the aspect ratio can be determined as 1.5.

When these insulation film materials are applied to CNT electron sources, impairment of the CNts do not occur at a curing temperature of 300° C. or less. Furthermore, from the viewpoint of degassing, since an adequately high heat-treatment has been performed once, an adsorbed gas, especially, water can be desorbed adequately. Water is a primary component of the gas adsorbed by a vacuum container inner wall. After this curing is completed, a high vacuum can easily be achieved by performing evacuation in a short time. When an FED is formed on a glass substrate, the glass will be cracked unless gradual heating and gradual cooling are performed. In particular, when heating is performed to a high temperature close to the softening point of the glass, the temperature must be gradually changed in order to avoid cracking of the glass. Since the curing temperature is a relatively low 300° C., the glass is unlikely to be cracked even when the temperature change is relatively rapid. In addition to this, since the maximum temperature to be achieved is low, the total time required for the heating and cooling can be reduced. Regarding the baking during evacuation, the total time required for the evacuation can be reduced by controlling the maximum temperature at 300° C. or less.

The benzocyclobutene (BCB) resin has a curing temperature within the range of 200° C. to 300° C., and can be cured without impairment of a CNT. This resin has heat resistance, a low thermal expansion coefficient, a low water absorption property and a low dielectric constant, and therefore, is suitable for an FED using the CNT. That is, the benzocyclobutene (BCB) resin can be degassed after an encapsulation step is performed at 300° C. At this time, the distortion of the film is small, and thereby, the distortion of glass is small even when a large glass substrate is used. Since the thermal expansion of the support material also affects the distortion during a heating step, preferably, a heat treatment is performed at 300° C. or less. Since the benzocyclobutene (BCB) resin has a low water supply property, a small amount of gas remains under vacuum, and thereby, the evacuation time can be reduced, and an irregular discharge due to a remaining gas can be suppressed. The remaining gas is ionized, falls onto a CNT, and causes damage to the CNT. From such a viewpoint as well, it is desirable that the remaining gas can be reduced. Consequently, the benzocyclobutene (BCB) resin is suitable for the FED.

On the other hand, in a method for manufacturing a field electron emission apparatus, even when exposure is performed in plasma while a metal protective film is arranged on the surface of the CNT, provision of the protective film performs a function of preventing disappearance of the fine structure of the CNT. Furthermore, when a part of the protective film is removed by chemical etching, and the CNT with no damage is exposed in order to serve as an electron source, these actions perform a function of exhibiting the electron emission characteristic inherent in the CNT.

Specific explanations will be made below regarding a method for manufacturing a field electron emission apparatus and a field electron emission apparatus produced by the same, with reference to some Examples.

### EXAMPLE 1

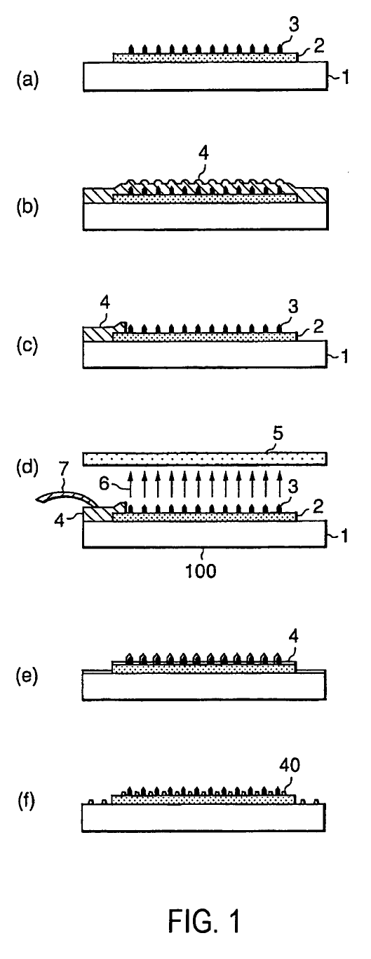

FIGS. 1(a) to (d) are sectional side views showing a manufacturing process for a diode-structure emitter (an intermediate product of a field electron emission apparatus) in a step-by-step manner. The process is a specific example of a method for manufacturing a field electron emission apparatus according to Example 1 of the present invention, and the emitter is composed of a cathode plate and a phosphor screen.

In the first step shown in FIG. 1(a), a CNT film 2 is formed on a glass substrate 1. The CNT film 2 is composed of a CNT and a binder component. The CNT is formed from carbon and a very small amount of metal additive, and the binder component serves to form the shape of a film. When the CNT film 2 is formed, the binder and the CNT are mixed, and the resulting paste-like material is formed on the glass substrate 1 by using the technique of screen printing. Alternatively, the CNT film 2 can be formed by, for example, a method in which the CNT is formed on a jig, the binder is formed on the CNT or the glass substrate 1, and thereafter, the CNT or the CNT and binder are transferred onto the glass substrate 1, followed by fixing.

The CNT film 2 includes a fine structure 3 in the film itself. In general, this fine structure 3 is in a condition in which one million or more of structures are included on a cubic millimeter basis, and the structure is in the shape of a tube or rod having a diameter (outer diameter) within the range of 1 nanometer to 100 nanometers and a length of 50 times or more than the diameter. The features of this fine structure 3 will be described below in detail. One end of the tube or rod protrudes from the surface of the CNT film 2. In general, a CNT protrudes from the surface by a length of 5 times or more than the diameter (outer diameter), and the number of places thereof is usually 100 or more on a square millimeter of the surface basis. Here, the fine structure 3 refers to a structure having all of the aforementioned features. An aluminum film 4 is adhered on the surface of the aforementioned fine structure 3, and thereby, a condition shown in FIG. 1(b) is brought about. The aluminum film 4 is to become a wiring, and serves a function as a protective film.

Regarding the second step shown in FIG. 1(b), the aluminum film 4 is formed by a method of board-heating evaporation, electron-beam evaporation, sputter deposition, CVD or the like. The board-heating evaporation or the electron-beam evaporation is an evaporation step in a vacuum apparatus. The film thickness of the aluminum film 4 is determined in accordance with the diameter (outer diameter) of the fine structure 3, is specified to be within the range of 0.1 to 100 times the diameter (outer diameter), and preferably be within the range of 2 to 3 times the diameter (outer diameter). Here, the film thickness is defined as an average film thickness in the case where the aluminum film 4 is deposited as a continuous film on a flat substrate. When the aluminum film 4 is adhered within the range of 0.1 to 100 times the diameter (outer diameter), the film thickness does not always become the average film thickness all over the adhered region. When the film thickness of the aluminum film 4 is 0.1 to 100 times the diameter of the CNT, some portions of the CNT film 2 may not be covered with the aluminum film 4. When the film thickness of the aluminum film 4 is within the range of 2 to 3 times the diameter of the CNT, and deposition is performed by a sputtering apparatus, the CNT film 2 is completely covered with the aluminum film 4.

Here, a result has been obtained, and shows that an adequate film thickness of the aluminum film 4 is 600 nm or more. For example, after the CNT film 2 is deposited, a flat glass plate is press-contacted with the CNT surface, and subsequently, the glass plate is removed. When a series of these operations are performed, the CNT film 2 is adhered to the glass substrate 1. On the other hand, a phenomenon occurs in which a part of a tube tip rises toward a direction perpendicular to the surface, wherein the tube is the fine structure 3 on the surface of the CNT film 2. In the case where aluminum is sputtered under this condition, when the sputter film thickness is small, a pinhole may occur in the film, and the film may become inadequate as a protective film. An experimental result shows that the aluminum sputter must be made into a film having a film thickness of 600 nm or more in order to protect the CNT film 2 from burning due to plasma during an ashing step. In the ashing step, ashing is applied to the CNT film 2 including the aluminum film 4. However, the film thickness of the aluminum sputter can be decreased in half by suppression of the rise here.

After the condition shown in FIG. 1(b) is brought about, the aluminum film 4 is coated with a photosensitive resist, and subsequently, exposure and development are performed in order that a part of the resist remains on the CNT film 2. The maximum heat treatment temperature is specified to be 150° C. during a series of steps from the coating to the development. The glass substrate 1 is immersed in an etching solution for aluminum, for example, phosphoric acid solution, while a part of the photosensitive resist remains, as described above. In this manner, the aluminum film 4 is dissolved and is removed. Subsequently, the photosensitive resist is removed with a releasing solution, and a condition shown in FIG. 1(c) is brought about.

Regarding the condition in the third step shown in FIG. 1(c), the aluminum film 4 partially remains at the left end, and the fine structure 3 of the surface of the CNT film 2 is exposed on the portion other than the left end portion. The fine structure 3 remains even after a series of steps from the formation of the aluminum film 4 to the removal of the resist. This was verified by the observation with a scanning electron microscope (SEM). The aluminum film 4 on the CNT film 2 is not necessarily completely removed because emission can be performed as long as the fine structure 3 is exposed even though a part of the aluminum film 4 remains.

Regarding the condition shown in this FIG. 1(c), the glass substrate 1 can be referred to as a cathode plate 100 after a cathode lead wiring 7 is attached to the aluminum film 4 by a welder, as is in the condition of the fourth step shown in FIG. 1(d). This cathode plate 100 is a substrate for emitting electrons, and a phosphor screen 5 is oppositely arranged in close proximity to the surface thereof at a distance of 1 mm from the surface. When a voltage is applied at 1 kV between the phosphor screen 5 and the cathode plate 100 in order that the phosphor screen 5 carries a higher positive voltage, emitted electrons 6 are emitted from the fine structure 3, and allow the phosphor screen 5 to emit light. The changes in orbits of the emitted electrons 6 react sensitively to the surrounding magnetism. Consequently, when an intermediate product of the field electron emission apparatus is constituted here, the intermediate product can be used as a magnetic sensor, or be used as a backlight for a display panel or an LCD.

In this Example 1, the protective film was specified to be the aluminum film 4. However, for example, copper, molybdenum, titanium, tungsten, gold and silver can be used for the protective film, as a metal other than the aluminum film 4. Furthermore, the structure may be changed to a structure in which protection is performed with an insulation film of silicon dioxide, aluminum oxide, etc., and the lead is performed with an electrode of aluminum, etc.

### EXAMPLE 2

FIGS. 1(e) and (f) are sectional side views showing stages in a manufacturing process for a field electron emission apparatus. This process is a specific example of a method for manufacturing a field electron emission apparatus according to Example 2 of the present invention. The stages shown in FIGS. 1(e) and (f) are individually substitutes for the condition of the second step shown in FIG. 1(b) through the condition of the fourth steps shown in FIG. 1(d), and in the stages, the fine structure 3 is in the condition of being covered with an aluminum film.

The condition of the fourth step shown in FIG. 1(e) indicates a condition in which the aluminum film 4 having a film thickness of 10 nm is adhered to the fine structure 3. Here, the aluminum film 4 protects the fine structure 3 from a reaction during the process, and in addition, the fine structure 3 is covered with the aluminum film 4. Consequently, the aluminum film 4 becomes a part of the fine structure 3, and the function of emitting electrons can still be maintained. Since 10 nm of aluminum film 4 has been deposited onto portions other than the emitters, this film is selectively removed by lift-off, etc. Subsequently, an electrode is formed, and therefore, a function as a field electron emission apparatus is provided.

On the other hand, a condition of the fifth step shown in FIG. 1(f) is an example in which another fine structure 3 has been formed by the aluminum film 4 as the protective film. After the aluminum film 4 is adhered in a manner similar to that in the condition of the fourth step shown in FIG. 1(e), the aluminum film 4 is coagulated by heating at 300° C. or more in a vacuum. In this condition, the aluminum film 4 becomes in the condition of aluminum lumps 40. The aluminum lumps 40 are now distributed like islands, and cannot be referred to as a continuous film. The islands of the aluminum lumps 40 are formed from fine particles of aluminum, and some of the islands adhere to tubular- or rod-like tip portions of the fine structure 3 as spheres having diameters smaller than the outer diameters of the tubes or rods. In this condition, the service as a field electron emission apparatus is performed.

### EXAMPLE 3

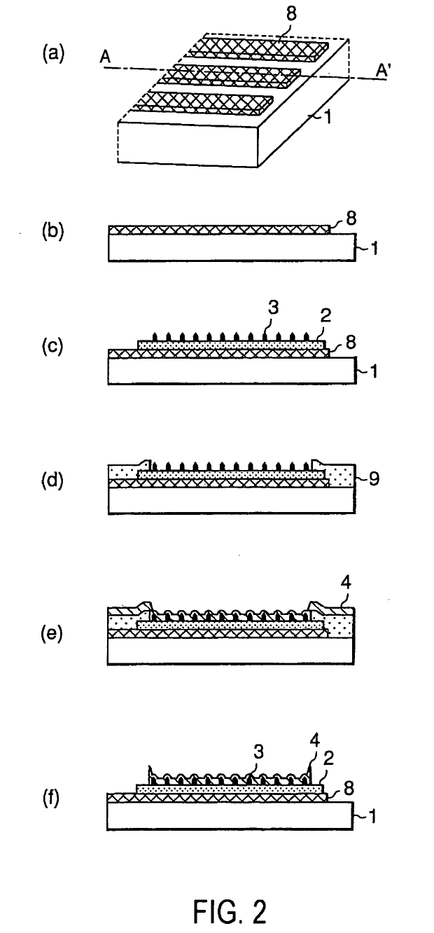

FIGS. 2(a) to (f) are sectional side views showing a manufacturing process for a field electron emission apparatus in a step-by-step manner. The process is a specific example of a method for manufacturing a field electron emission apparatus according to Example 3 of the present invention, and in this process, a cathode wiring is arranged on a glass substrate, and thereafter, a CNT film is deposited.

As the first step, cathode wirings 8 are patterned on a glass substrate 1 into a stripe-like shape. The resulting pattern of the cathode wirings 8 is shown in a partial perspective view shown in FIG. 2(a), and in a sectional side view shown in FIG. 2(b) in the direction A-A′ indicated in FIG. 2(a).

As the second step, a CNT film 2 is formed on the cathode wiring 8. In the resulting condition, a fine structure 3 is arranged on the surface of the CNT film 2, as shown in FIG. 2(c). Here, the CNT film 2 is formed on each of the wirings of the cathode wirings 8 on the stripe without extending off the wiring.

As the third step, a coating of photosensitive resist is applied to portions other than the fine structure 3 on the CNT film 2 surface on the glass substrate 1 in the condition of the second step shown in FIG. 2(c). Subsequently, exposure development is performed. In the resulting condition, a resist film 9 is arranged, as shown in FIG. 2(d). Here, the fine structure 3 is exposed in order that the CNT film 2 and the resist film 9 overlap with each other by 1 μm.

Subsequently, as the fourth step, aluminum evaporation is applied to the glass substrate 1 in the condition of the third step shown in FIG. 2(d) in an electron-beam evaporation apparatus. In the resulting condition, as shown in FIG. 2(e), the aluminum film 4 is deposited as the protective film on both of the resist film 9 and exposed fine structure 3. The aluminum film 4 has a thickness of the deposited film of 100 nm.

Thereafter, as the fifth step, the resist film 9 is removed from the glass substrate 1 in the condition of the fourth step shown in FIG. 2(e) with a releasing solution. In the resulting condition, the resist film 9 and the aluminum film 4 are removed, as shown in FIG. 2(f). That is, the deposited aluminum film 4 is benched at the end of the exposed portion. Consequently, when the releasing solution penetrates under the aluminum film 4, and the resist film 9 is removed, the aluminum film 4 on the resist film 9 is removed together with the resist film 9. This technique is referred to as lift-off.

Finally, the aluminum film 4 is removed with a phosphoric acid solution, etc., and thereafter, the service as a field electron emission apparatus is performed. When the aluminum film 4 is thin, as shown in Example 2, the service as a field electron emission apparatus can be performed in this condition. In addition, when an electrode is formed after the lift-off as well, the service as a field electron emission apparatus can be performed. In some cases, the service as a field electron emission apparatus can be performed after a heat treatment step is performed.

### EXAMPLE 4

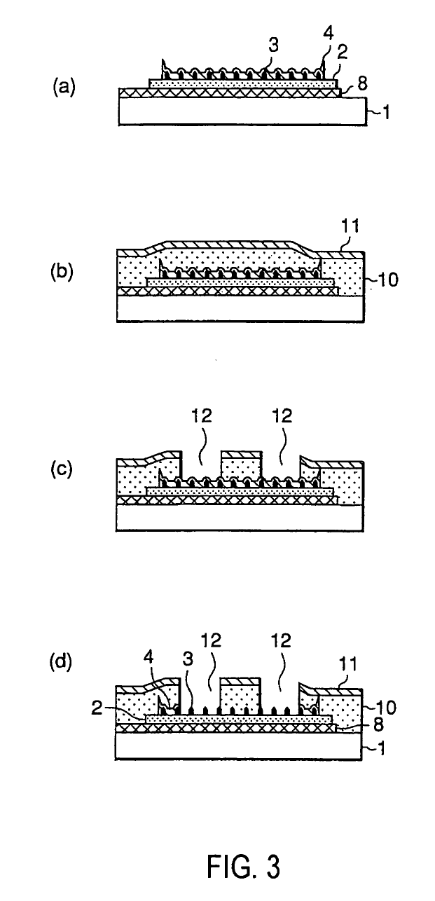

FIGS. 3(a) to (d) are sectional side views showing a manufacturing process for a triode-structure field electron emission apparatus in a step-by-step manner, and this apparatus has a gate conductive film. The process is a specific example of a method for manufacturing a field electron emission apparatus according to Example 4 of the present invention. Here, the fine structure 3 is an electron emission source, and is assumed to be the cathode electrode. In addition, a structure referred to as a triode structure includes three electrodes composed of a cathode electrode, a gate electrode and an electron capture electrode (a phosphor screen and a metal anode electrode). In this triode structure, the amount of emitted electrons can be controlled by adjusting a potential difference between the gate electrode and the cathode electrode.

Since the first step shown in FIG. 3(a) is the same as the condition shown in FIG. 2(f), explanations thereof are omitted.

In the second step shown in FIG. 3(b), the surface of the structure shown in FIG. 3(a) is spin-coated with any one of an epoxy resin, an acrylic resin, an epoxyacrylate resin and a polyimide resin so as to have a thickness of 10 μm, firing is performed at a temperature in the order of 200° C., and therefore, an insulation layer 10 is formed. Subsequently, a metal (for example, tungsten, molybdenum and gold) is formed as a gate conductive film 11 on the surface thereof so as to have a thickness of 200 nm.

In the third step shown in FIG. 3(c), emitter holes 12 are formed by dry etching with respect to the insulation layer 10 and the gate conductive film 11 on the glass substrate 1 in the condition shown in FIG. 3(b). Since a protective film is arranged as the aluminum film 4 on the fine structure 3 of the CNT, the impact of the ion during dry etching does not affect the impairment or breakage of the fine structure 3. When the insulation layer 10 is formed directly on the CNT film 2, in general, the CNT film 2 and the insulation film material do not conform to each other. Therefore, coating may be performed only partially, and variations in film thickness are likely to occur because thin portions and thick portions are brought about. However, since the aluminum film 4 is arranged on the CNT film 2 here, good conformity with the insulation film material is achieved, and uniform coating can be performed.

In the condition resulting from the fourth step shown in FIG. 3(d), the aluminum film 4 in the emitter holes 12 in the condition shown in FIG. 3(c) has been removed with an etching solution for aluminum, for example, phosphoric acid. In this condition, the service as a field electron emission apparatus is performed. When the present example is applied, impairment can be prevented during processing of the insulation layer 10 and the gate conductive film 11.

In particular, in the third step shown in FIG. 3(c), the service is sometimes performed as a field electron emission apparatus having a triode structure. When the service is performed as an FED in the condition shown in FIG. 3(c), the degree of vacuum is specified to be in the 10⁻² Pa range during evacuation in a low-profile container form of the FED, and a potential difference in the order of 18 V is applied between the gate conductive film 11 and the cathode wiring 8. The aforementioned potential difference does not cause discharge breakdown. In this manner, a part of remaining gases are ionized, rush into the aluminum film 4, and gradually remove aluminum. The application of the voltage is stopped at the time when the fine structure 3 is exposed, a high vacuum of 10⁻⁴ Pa is further established, and thereafter, usual operations are performed.

### EXAMPLE 5

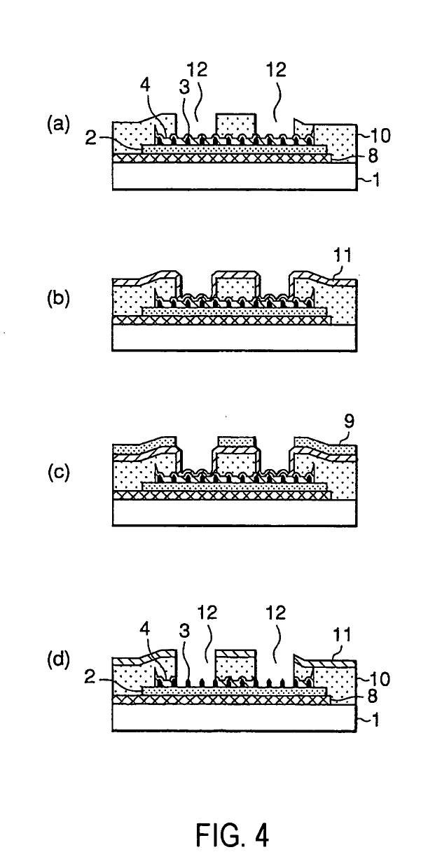

FIGS. 4(a) to (d) are sectional side views showing a manufacturing process for a triode-structure field electron emission apparatus in a step-by-step manner, and this apparatus has a gate conductive film. The process is a specific example of a method for manufacturing a field electron emission apparatus according to Example 5 of the present invention.

FIG. 4(a) shows the condition resulting from the first step. In this step, after the condition shown in FIG. (a) is brought about, a photosensitive insulation film 10 is deposited, and emitter holes 12 are formed by performing a exposure development step. The emitter hole 12 has a diameter of 20 μm and a depth of the hole of 5 μm. However, adhesion of the gate conductive film 11 is not performed in contrast to the second step shown in FIG. 3(b). The photosensitive insulation film 10 is composed of a photosensitive resist, a photosensitive polyimide resin, photosensitive SOG, an epoxyacrylate resin having a fluorene skeleton or a benzocyclobutene (BCB) resin. Chemical impairment due to a development solution does not occur during development because the aluminum film 4 serves as a protective film.

FIG. 4(b) shows the condition resulting from the second step. In this step, 20 nm of conductive film 11 was arranged on the surface in the condition shown in FIG. 4(a) by deposition of aluminum with a sputtering apparatus.

FIG. 4(c) shows the condition resulting from the third step. In this step, a coating of resist film 9 was applied by spin coating on the gate conductive film 11 in the condition shown in FIG. 4(b), alignment was performed in order that the positions of emitter holes 12 and the portions of the resist film 9 to be removed became in agreement, and exposure and development were performed.

Finally, FIG. 4(d) shows the condition resulting from the fourth step. In this step, the gate conductive film 11 made of aluminum and the aluminum film 4 in the emitter holes 12 in the condition shown in FIG. 4(c) are simultaneously removed with an etching solution for aluminum, for example, phosphoric acid. In this condition, the service as a field electron emission apparatus is performed.

### EXAMPLE 6

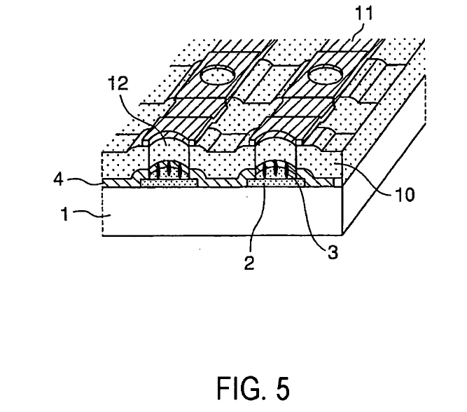

FIG. 5 is a perspective cutaway view of a part of the basic configuration of an FED as a field electron emission apparatus according to Example 6. In the FED, gate conductive films 11 are arranged by patterning into a stripe-like shape.

This FED has a configuration constituted as described below. Island-like CNT films 2 are two-dimensionally arranged with a spacing therebetween on a glass substrate 1, an aluminum film 4 is patterned into a horizontally stripe-like shape so as to cover the CNT film 2, and an insulation film 10 is laminated all over the surface of the glass substrate 1 while the CNT film 2 and the aluminum film 4 are arranged on the surface. Emitter holes 12 are formed, and subsequently, the gate conductive films 11 are patterned into a vertically stripe-like shape on the upper portion of the emitter holes 12.

In this FED, since the aluminum film 4 is in contact with the glass substrate 1 at the portions with no CNT film 2, the aluminum film 4 has excellent adhesion, and further serves a function as a cathode wiring. The gate conductive films 11 and the aluminum film 4 intersect with each other at a right angle, and constitute a stripe-shaped wiring, while the aluminum film 4 serves a function as a cathode wiring as well. In addition, the bottom of the emitter hole 12 has a structure in which a fine structure 3 of the CNT film 2 is exposed.

### EXAMPLE 7

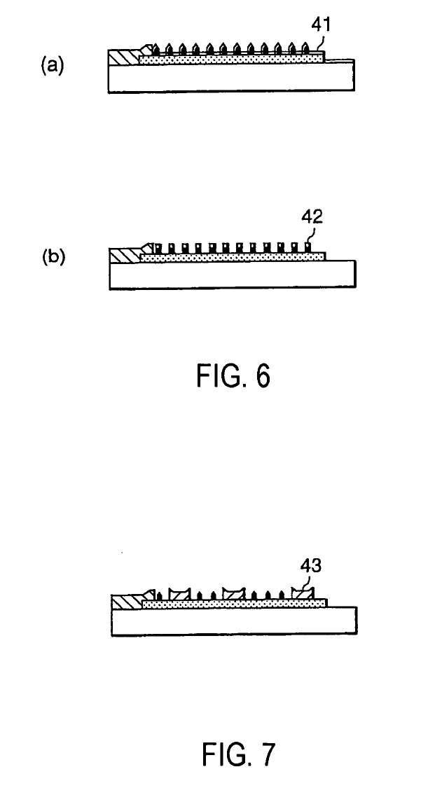

FIGS. 6(a) and (b) are sectional side views showing a manufacturing process for a field electron emission apparatus in a step-by-step manner. The process is a specific example of a method for manufacturing a field electron emission apparatus according to Example 7 of the present invention, and in this process, a protective film reacts with a fine structure.

In the first step shown in FIG. 6(a), 1 nm of titanium film 41 is adhered on a CNT film 2 including a fine structure 3. The titanium film 41 is made of a titanium metal, and is in place of the aluminum film 4. The titanium film 41 functions as a protective film. In the second step shown in FIG. 6(b), a heat treatment is performed in a vacuum at 500° C. for 10 minutes, and thereby, the titanium metal of the titanium film 41 reacts with carbon in the CNT film 2, so that titanium carbide 42 reformed into titanium nitride is formed at the tubular end portions of the fine structure 3. In this condition, the service as a field electron emission apparatus is performed.

### EXAMPLE 8

FIG. 7 is a sectional side view showing a step of forming pointed-structure aluminum 43 as a specific example of a method for manufacturing a field electron emission apparatus according to Example 8 of the present invention. The aluminum film 4 is formed as a protective film in the early stages of the manufacturing process of a field electron emission apparatus of each of the aforementioned Examples. Subsequently, a part of the aluminum film 4 is removed, and in that condition, the corner portions of the aluminum film 4 are pointed at a right or acute angle in order that an electric field is concentrated on the corner portions.

Since the pointed-structure aluminum 43 pointed at a right or acute angle is formed in the vicinity of a CNT film 2, and thereby, a field electron emission apparatus is manufactured, an electric field is concentrated on the corner portions of the pointed-structure aluminum 43. In addition, the electric field is further concentrated on the fine structure 3 of the CNT film 2 present in close proximity to the corner portion. Consequently, an electron emission characteristic is achieved, and exhibits a large current density with a low threshold value. In order to avoid the concentration of an electric field on the corner portions of the pointed-structure aluminum 43, the corner portion may be shaped to have an obtuse angle.

### EXAMPLE 9

A method for manufacturing a field electron emission apparatus according to Example 9 of the present invention is a step of forming an epoxyacrylate resin having a fluorene skeleton as an insulation film on the surface having the structure shown in the aforementioned FIG. 3(a).

The epoxyacrylate resin of 20 μm in thickness is formed by a spin coating method on the surface having the structure shown in FIG. 3(a). In the spin coating method, coating is performed for 1 to 10 seconds with the number of revolutions of 2,000 revolutions, and thereafter, drying is performed at a temperature condition of 70° C. for 40 minutes in an oven.

After exposure is performed with 365 nm of ultraviolet ray at within the range of 100 to 1,000 [mJ/cm²], development is performed for a treatment time within the range of 1 minute to 10 minutes by using a development solution containing, for example, sal soda, as an alkaline development solution. Thereafter, water washing is performed, and finally, heat curing is performed at a temperature within the range of 160° C. to 300° C.

Rough guidelines for the heat treatment conditions required for the aforementioned curing can include, for example, a heating time of 90 minutes at a heating temperature of 160° C., a heating time of 60 minutes at a heating temperature of 200° C., a heating time of 30 minutes at a heating temperature of 230° C. and a heating time of 1 minute at a heating temperature of 300° C., although the heating time varies depending on the heating temperature.

The epoxyacrylate resin is formed as the insulation film, has heat resistance of 300° C. or more, and has no problem with respect to water absorption. Therefore, operations are possible even under vacuum, such as in an FED. Furthermore, since the curing temperature is not necessarily raised to the order of 400° C., impairment of the CNT film 2 due to the temperature does not occur. High-temperature impairment of the CNT film 2 can be prevented by a treatment in an atmosphere of an inert gas, for example, nitrogen. However, in the present Example, no specific apparatus is required for bringing about such an atmosphere.

### EXAMPLE 10

A method for manufacturing a field electron emission apparatus according to Example 10 of the present invention is a step of forming a benzocyclobutene (BCB) resin having a fluorene skeleton as an insulation film on the surface having the structure shown in the aforementioned FIG. 3(a).

The benzocyclobutene (BCB) resin of 20 μm in thickness is formed by a spin coating method on the surface having the structure shown in FIG. 3(a). In the spin coating method, coating is performed for 30 to 120 seconds with the number of revolutions of 1,300 revolutions, and thereafter, drying is performed at a temperature condition of 70° C. for 30 minutes in an oven.

After exposure is performed with 365 nm of ultraviolet ray at within the range of 100 to 1,000 [mJ/cm²], development is performed for a treatment time within the range of 1 minute to 10 minutes by using a development solution similar to that in Example 9. Thereafter, water washing is performed, and finally, heat curing is performed at a temperature within the range of 150° C. to 300° C.

Rough guidelines for the heat treatment conditions required for the aforementioned curing can include, for example, a heating time of 120 minutes at a heating temperature of 150° C. and a heating time of 10 minutes at a heating temperature of 300° C., although the heating time varies depending on the heating temperature.

The benzocyclobutene (BCB) resin is formed as the insulation film, has heat resistance of 300° C. or more, and has no problem with respect to water absorption. Therefore, operations are possible even under vacuum, such as in an FED. Furthermore, since the curing temperature is not necessarily raised to the order of 400° C., impairment of the CNT film 2 due to the curing temperature does not occur.

Electron emission characteristics were compared between an electron gun using a CNT film 2 including an insulation film made of the aforementioned epoxyacrylate resin having a fluorene skeleton or benzocyclobutene (BCB) resin and an electron gun using a CNT film 2 including an insulation film made of the polyimide resin heat-cured at 400° C. As a result, the electric field strength was 2 V/μm and the emission current density was 1 [mA/cm²] with respect to the electron gun using the epoxyacrylate resin having a fluorene skeleton or benzocyclobutene (BCB) resin, wherein the electric field strength was determined by dividing a gate voltage by a distance between the gate and the CNT film 2. On the other hand, the electric field strength was 4 V/μm and the emission current density was 1 [mA/cm²] with respect to the electron gun using the polyimide resin heat-cured at 400° C. Furthermore, even when the curing temperature was changed within the aforementioned range, no difference is observed in the current densities with respect to the electron gun using the epoxyacrylate resin having a fluorene skeleton or benzocyclobutene (BCB) resin, while the CNT film 2 was impaired, and thereby, emission was impaired with respect to the electron gun using the polyimide resin heat-cured at 400° C.

Regarding the formation of the insulation films according to the aforementioned Examples 9 and 10, the spin coating method was described as the coating method. However, a die coating method, a carton coating method or printing method may be applied in place of this. Not only the coating, but also a covering method may be applied, in which a film-like membrane is laminated. When the film-like membrane is laminated, and thereafter, a hole is formed in a resin, an insulation film can be formed without spin coating. When an emitter hole is formed before the film-like membrane is laminated, a CNT is not exposed to a solution because no wet treatment, such as a development step and a washing step, for forming the hole is required.

Regarding the structures in the aforementioned Examples 9 and 10, the insulation film was formed on the CNT film 2 shown in FIG. 3(a), as described above. However, alternatively, a gate structure may be formed, a CNT film 2 may be formed by printing, etc., in an emitter hole, and thereafter, an insulation film may be formed in a manner similar to that in the above description. At this time, it is better that the curing temperature of the insulation film is high, and the polyimide resin is suitable regarding selection of the insulation film material. However, preferably, the insulation film is formed by dry etching or other methods in consideration of reproducibility and uniformity of the emitter hole shape in order that reproducibility and uniformity are improved.

In addition, each of the resins exemplified as the insulation film materials may have a multilayer structure in accordance with purposes. In the case where the multilayer structure is adopted, adhesion can be increased, or the expansion coefficient can be adjusted with respect to the glass substrate 1. In order to improve adhesion to the substrate, gate electrode and the like, the substrate and the insulation film may be coated with a coupling agent, for example, a silane-based coupling agent, or asperities may be formed on the surface by buffing, etc., so as to achieve excellent adhesion.

### EXAMPLE 11

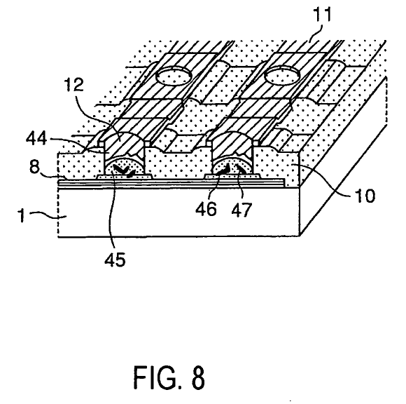

FIG. 8 is a perspective cutaway view of a part of the basic configuration of an FED as a field electron emission apparatus according to Examples 11. In the FED, gate conductive films 11 are patterned into a stripe-like shape. In this FED, a titanium metal is exposed at the surface of a cathode wiring 8. According to an experimental result, a CNT transfer film has better adhesion when transferred on a wiring of a titanium metal surface compared with that on a wiring of, for example, a gold surface. Regarding a CNT thin film transferred on the gold wiring, a part of the CNT film may float when immersed in an ethanol solution, whereas the CNT film on the titanium wiring does not float under the same condition.

Regarding the FED in which the titanium metal is exposed at the surface of the cathode wiring 8, any step of dissolving the titanium metal cannot be performed in succeeding processes. Consequently, in the present Example, the material for the gate wiring and the protective film is specified to be aluminum, and the gate conductive film 11 and the aluminum protective film 46 are formed. Since aluminum dissolves into an alkaline solution as well, patterning can be performed without damage to the titanium metal.

### EXAMPLE 12

Regarding a field electron emission apparatus according to Example 12 of the present invention, an aluminum protective film 46 is exposed to ashing plasma while a part of or all of an emitter hole inner wall is covered with aluminum (a metal of a gate wiring material) of a gate conductive film 11 in the FED shown in FIG. 8. In the FED, the gate conductive film 11 has been patterned into a stripe-like shape.

That is, this FED is similar to that described in FIG. 5 except for the portions described below. Emitter-hole-remaining aluminum 44 adheres to the inner wall of emitter holes 12, as shown in the drawing. The manner of adhesion of this emitter-hole-remaining aluminum 44 will be expressed in words. From the top portion to the central portion of the emitter hole inner wall is completely covered with aluminum, and a part of the resin inner wall of the emitter hole is exposed at the emitter hole bottom 45. Here, aluminum of 200 nm in thickness, for example, is deposited by sputtering, a coating of a photoresist is applied, a photoresist of a pattern having a diameter smaller than the emitter diameter by 10% is removed by development, and thereafter, dissolution is performed with an alkaline solution. In this manner, a part of the emitter hole bottom 45 with the end portion in a round shape protruding in an inward direction is dissolved so as to take the shape shown in the drawing, and a cardo resin is exposed at the surface thereof. The aluminum protective film 46 at the emitter hole bottom 45 has been deposited with a thickness of 1 micron in advance of performance of a series of steps described above, and therefore, remains after immersion in the aforementioned alkaline dissolving solution. A part of the cardo resin residue 47 on the aluminum protective film 46 is removed by a lift-off action due to immersion in this alkaline dissolving solution. However, a part of the cardo resin residue 47 remains, as shown in the drawing.

When ashing is performed in this condition with oxygen plasma, the cardo resin residue 47 is burnt off by the ashing. Subsequently, a coating of a photoresist is applied, a photoresist of a pattern having a diameter larger than the emitter diameter by 10% is removed by development, and thereafter, dissolution is performed with an alkaline solution. Aluminum is thereby completely removed from the emitter hole inner wall and the emitter hole bottom 45. Consequently, the CNT in the vicinity of the emitter hole bottom 45 and the gate wiring composed of the gate conductive film 11 are brought into an insulated condition.

### EXAMPLE 13

In Example 13, the insulation film described in each of the aforementioned Examples is specified to be a photosensitive material (may be an organic photosensitive material). Explanations will be made without using any drawing. The case where a gate insulation film is colored at, for example, 300° C. can be exemplified.

In the case where a transparent cardo resin is used as a photosensitive resin material, when heated to 350° C. in air, the color of the cardo resin changes to golden brown. Since the cardo resin remains transparent after heating to 300° C. or less, when the color changes to golden brown burnt umber, the change is noticed at first glance. For example, an operator thereby notices an irregular heating history by visual observation.

When the FED panel has a history of heating at 350° C. or more in air, the initial emission efficiency is low, and furthermore, a life characteristic is poor (emission attenuates early). However, in the present Example, the condition of the CNT can be estimated by monitoring the color of the cardo resin. When the heating is performed in a nitrogen atmosphere, the cardo resin is not colored even at 350° C., and no change (impairment) occur in the characteristic of the CNT. Consequently, the aforementioned viewpoints can be used for checking irregularity in the nitrogen atmosphere and occurrence of contamination with oxygen, during the heating at 350° C.

As described above, according to the field electron emission apparatus of the present invention, the protective film formation step is performed in order to form the protective film on the surface of the CNT during a manufacturing process of at least a part of the apparatus. Consequently, occurrence of damage to the CNT can be prevented during the manufacturing process. The electron emission characteristic is ensured adequately, and therefore, a large current density is exhibited with a low threshold value. This characteristic is inherent in the CNT. The field electron emission apparatus is manufactured to have a diode structure or a triode structure, and can be easily configured to have high performances. In particular, when the triode structure is manufactured by depositing the insulation layer on the CNT film, an effect is produced so that the film thickness of the insulation film can be optimized and be made uniform. Since the photosensitive resin is used as the gate insulation film, the triode structure can be formed with ease. In addition, since the firing temperature is a low temperature, the CNT is not damaged.

1. A method for manufacturing a field electron emission apparatus using a carbon nanotube as an electron source, the method comprising a protective film formation step of forming a protective film on the surface of the carbon nanotube during a manufacturing process of at least a part of the apparatus.

2. The method for manufacturing a field electron emission apparatus according to claim 1, wherein steps to be performed in the protective film formation step comprise a heating step, a heat treatment step, a plasma treatment step, a plasma etching step, a step of forming a film in any one of a gas phase, plasma, a liquid phase, and a solid phase, a step of performing an etching with a solution or a surface treatment, and at least one of the steps of resist coating, resist development and resist peeling.

3. The method for manufacturing a field electron emission apparatus according to claim 1 or 2, wherein the protective film has conductivity in the protective film formation step.

4. The method for manufacturing a field electron emission apparatus according to any one of claims 1 to 3, wherein the protective film formation step comprises a step of exposing the protective film in plasma while the protective film is arranged on the surface of the carbon nanotube.

5. The method for manufacturing a field electron emission apparatus according to claim 4, wherein the protective film formation step further comprises a step of removing a part of the protective film by chemical etching.

6. The method for manufacturing a field electron emission apparatus according to any one of claims 1 to 5, wherein aluminum is used as the protective film.

7. The method for manufacturing a field electron emission apparatus according to claim 6, wherein the aluminum has an film thickness of 600 nm or more.

8. The method for manufacturing a field electron emission apparatus according to claim 6 or 7, wherein the carbon nanotube is formed by deposition onto a titanium metal wiring.

9. The method for manufacturing a field electron emission apparatus according to any one of claims 1 to 8, comprising a step of depositing a gate metal after ashing is applied to the carbon nanotube with the protective film on the surface thereof.

10. The method for manufacturing a field electron emission apparatus according to any one of claims 1 to 8, comprising the steps of depositing a gate metal onto the protective film, followed by patterning, and thereafter, exposing to ashing plasma.

11. The method for manufacturing a field electron emission apparatus according to claim 10, wherein the protective film is exposed to the ashing plasma while a part of or all of an emitter hole inner wall is covered with the gate metal.

12. The method for manufacturing a field electron emission apparatus according to claim 11, comprising a step of removing the gate metal covering the emitter hole inner wall after the protective film is exposed to the ashing plasma.

13. A method for manufacturing a field electron emission apparatus using a carbon nanotube as an electron source, the method comprising a step of reforming the carbon nanotube into titanium nitride by performing a heat treatment after a titanium film is formed on the surface of the carbon nanotube.

14. A method for manufacturing a field electron emission apparatus using a carbon nanotube as an electron source, the method comprising a step of forming fine particles of aluminum by performing a heat treatment after an aluminum film is formed on the surface of the carbon nanotube.

15. A method for manufacturing a field electron emission apparatus using a carbon nanotube as an electron source, the method comprising a step of forming a structure in which the protective film remaining in the vicinity of the carbon nanotube is pointed at a right or acute angle.

16. Afield electron emission apparatus manufactured by the method for manufacturing a field electron emission apparatus according to any one of claims 1 to 15, wherein a part of the protective film remains.

17. The field electron emission apparatus according to claim 16, wherein the protective film has conductivity and has a structure including a further function as a cathode wiring.

18. The field electron emission apparatus according to claim 17, wherein the protective film is arranged in contact with a substrate, as well, including no carbon nanotube.

19. The field electron emission apparatus according to claim 18, wherein an insulation film is laminated on the carbon nanotube covered with the protective film, and a gate conductive film is laminated on the insulation film.

20. The field electron emission apparatus according to claim 19, comprising a portion brought about by peeling of a part of the insulation film, gate conductive film, and protective film so as to expose the carbon nanotube.

21. The field electron emission apparatus according to any one of claims 17 to 20, wherein the insulation film is arranged between the cathode wiring or carbon nanotube and the gate conductive film, and is an organic material.

22. The field electron emission apparatus according to any one of claims 17 to 20, wherein the insulation film is arranged between the cathode wiring or carbon nanotube and the gate conductive film, and is a photosensitive material.

23. The field electron emission apparatus according to any one of claims 17 to 20, wherein the insulation film is arranged between the cathode wiring or carbon nanotube and the gate conductive film, and is an organic photosensitive material.

24. The field electron emission apparatus according to any one of claims 17 to 20, wherein the insulation film is arranged between the cathode wiring or carbon nanotube and the gate conductive film, and is a material which changes color in accordance with a heating history.

25. The field electron emission apparatus according to any one of claims 21 to 24, wherein the insulation film uses any one of a polyimide resin, an epoxy resin, an acrylic resin, an epoxyacrylate resin, an organic silicon-based resin and SOG (Spin on Glass) as a material.

26. The field electron emission apparatus according to any one of claims 21 to 25, wherein the insulation film comprises the epoxyacrylate resin having a fluorene skeleton or a benzocyclobutene resin.

27. The field electron emission apparatus according to any one of claims 21 to 26, wherein the insulation film is arranged by curing performed under a heating temperature condition of 300° C. or less.

28. The field electron emission apparatus according to any one of claims 21 to 27, wherein the insulation film changes color in air under a heating temperature condition of 300° C. or more.

29. The field electron emission apparatus according to any one of claims 21 to 28, wherein the insulation film changes color in an atmosphere of nitrogen under a heating temperature condition of 450° C. or more.
